(19) United States
(12) Patent Application Publication
(10) Pub. No.: US 2004/0161069 A1
(43) Pub. Date: Aug. 19, 2004

(54) Method for synchronizing data frames in a digital communication system

(75) Inventor: Su-Hyung Eom, Suwon-shi (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., KYUNGKI-DO (KR)

(21) Appl. No.: 10/777,430

(22) Filed: Feb. 12, 2004

(30) Foreign Application Priority Data
Feb. 13, 2003 (KR) 9070/2003

(51) Int. Cl. H04L 25/38

(52) U.S. Cl. 375/369

(57) ABSTRACT

A method for synchronizing data frames in a communication system, and in particular an apparatus and method for preventing flag emulation in a system for synchronizing data frames using flags, in which a start and an end of each data frame having a data sequence to be transmitted are indicated using a flag. The method comprises classifying the data sequence into a plurality of unit data sequences, the step of inputting the unit data sequences into a predetermined table as indices, the step of outputting output data sequences having dummy bits which are alternatively inserted from the table in correspondence to the indices, and the step of attaching the flags to front and rear ends of the each data frame, respectively.

### PRIORITY

This application claims priority to an application entitled “Method for Synchronizing Data Frames in a Digital Communication System” filed in the Korean Industrial Property Office on Feb. 13, 2003 and assigned Serial No. 2003-9070, the contents of which are hereby incorporated by reference.

### BACKGROUND OF THE INVENTION

1. Field of the Invention

The present invention relates generally to synchronization of data frames in a communication system, and more particularly to an apparatus and method for preventing flag emulation in a system for synchronizing data frames using flags.

2. Description of the Related Art

There are several standards for visual communication through a wireless channel, e.g., video, audio, etc. For instance, a standard H.324/M includes a standard H.223 for multiplexing/demultiplexing, a standard H.263 and MPEG-4 (Moving Picture Experts Group standards 4) for video signal coding, AMR (Adaptive Multi-Rate) for audio signal coding, and a standard H.245 for control data coding. Data for video, audio, and controlling is encoded using the foregoing standards, and the encoded data is adaptively multiplexed/demultiplexed by a Protocol Data Unit (PDU) based on the standard H.223 for multiplexing/demultiplexing.

Data of the PDU is encapsulated to form a frame according to a High Level Data Link Control (HDLC) protocol. The HDLC protocol is a transport protocol which is used at the second layer, i.e., a data link layer, of all seven layers in the Open System Interconnect (OSI) reference model for data communication and inserts information for performing data flow control and data error correction into data frames. In HDLC, flags separate these frames. That is, the HDLC protocol makes use of HDLC flags to indicate the start or end of the frame. Each HDLC flag is a unique bit sequence, for instance, denoted by six consecutive “1” bits, i.e., 01111110 (0×7e). This bit pattern is used as a flag sequence resulting from the fact that the pattern has a bilateral symmetry, that the continuous flags have a periodic clock waveform, and that the pattern is not frequently generated in typical text, such as in ASCII code.

FIG. 1 illustrates a mode in which HDLC flags are used. As illustrated in FIG. 1, the HDLC flags are placed at the beginning and end of an HDLC frame, and thereby the start and end of the HDLC frame are indicated.

The HDLC frames are delimited by a sequence of bits known as a “flag”. The flag sequence must never occur within the data sequence of PDU to be transmitted. When the same sequence as the flag sequence is generated within the data sequence of PDU to be transmitted, a flag emulation is generated that causes the generated sequence to be confused with an intentionally sent flag on a receiver side.

A technique of zero bit insertion is known, which is used to prevent the foregoing flag emulation. This zero bit insertion is a process in which the data sequence of PDU to be transmitted is checked by a bit unit, and when a “1” bit is sequentially generated up to five (5) times, a “0” bit is inserted after any sequence of five consecutive “1” bits. Further, when a sixth bit after five consecutive “1” bits is the “0” bit on the receiver side, this “0” bit is considered as a dummy bit inserted on the transmitter side, and the “0” bit is removed. However, when the sixth bit is the “1” bit, these consecutive “1” bits are considered as a flag.

The zero bit insertion ensures transparency of the HDLC by enabling the HDLC protocol to be used with respect to any data sequence. However, there is a problem in that the data sequences of PDU should be checked by a bit unit, and thus, the system is operated at a lower speed. In particular, in the system using a low-speed central processing unit (CPU) such as a mobile terminal, which is designed on the basis of a lower power, the method of inserting the “0” bit after data sequences are checked by a bit unit as in the prior art imposes a great load on the CPU.

Meanwhile, a chip that puts the zero bit insertion process into practice in a form of hardware has been developed in order to reduce the load imposed on CPU. However, there is another problem in that the hardware chip is difficult to debug, and also lowered compatibility with the other systems.

### SUMMARY OF THE INVENTION

Accordingly, the present invention has been designed to solve the above-mentioned problems occurring in the prior art, and an object of the present invention is to provide a method for synchronizing data frames capable of preventing flag emulation without decreasing a processing speed in a communication system.

In order to accomplish the above and other objects, according to one aspect of the present invention, there is provided a method for synchronizing data frames in a communication system in which the start and end of each data frame having a data sequence to be transmitted are indicated using flags having a predetermined sequence, the method comprising the steps: of classifying the data sequence into a plurality of unit data sequences having a predetermined bit number, and sequentially inputting the unit data sequences into a predetermined table as indices; outputting output data sequences from the table in correspondence to the indices, the output data sequences having dummy bits which are alternatively inserted; and forming the data frame from the output data sequences, and attaching the flags to front and rear ends of the data frame, respectively.

According to another aspect of the present invention, there is provided a method for synchronizing data frames in a communication system in which the start and end of each data frame having a data sequence are indicated using flags having a predetermined sequence, the method comprising the steps of:

classifying a received data sequence into a plurality of unit data sequences having a predetermined bit number; sequentially inputting the unit data sequences into a predetermined table; and sequentially outputting the output data sequences, from which the dummy bits are removed, from the table in correspondence to the input unit data sequences.

### BRIEF DESCRIPTION OF THE DRAWINGS

The above and other objects, features, and advantages of the present invention will be more apparent from the following detailed description taken in conjunction with the accompanying drawings, in which:

FIG 1 illustrates HDLC flags indicating the start and end of a typical HDLC frame;

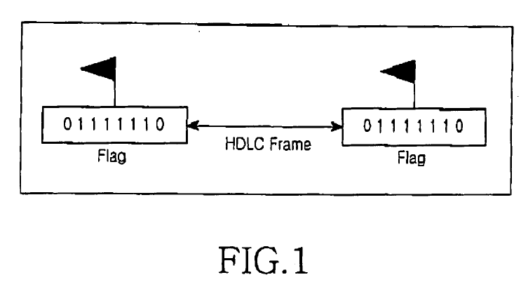

FIG. 2 is a flow chart illustrating a method for alternatively inserting dummy bits into data sequences which are to be transmitted on a transmitter side, according to a preferred embodiment of the present invention; and

FIG 3 is a flow chart illustrating a method for removing dummy bits from data sequences, which are received from a receiver side according to a preferred embodiment of the present invention.

### DETAILED DESCRIPTION OF THE PREFERRED EMBODIMENT

Preferred embodiment of the present invention will be described in detail herein below with reference to the accompanying drawings. It is noted that like reference characters designate the same or similar parts throughout the drawings even though they are indicated different drawings. In the following description of the present invention, a detailed description of known functions and configurations incorporated herein will be omitted when it may make the subject matter of the present invention rather unclear.

The present invention provides a method, in which data sequences (each known as a Protocol Data Unit (PDU)) to be transmitted are not checked by a bit unit, the data sequences are classified into a plurality of unit data sequences by a unit of a predetermined bit number, and each unit data sequence is checked in a lump with reference to a table. Herein, the following description will be made on the assumption that data sequences are classified into unit data sequences by a unit of 1 byte. However, it should be noted that the present invention is easily applied to the case that data sequences are divided into unit data sequences by a bit unit other than the 1-byte unit. Further, the present invention will be described on the assumption that the flag used is an HDLC flag, i.e., a sequence of the form 01111110 (0×7e), but it should be noted that the present invention is also applicable to the case that the flag used is another flag having the same characteristic.

Table 1 shows a part of the table which is used to perform detection and conversion of a bit sequence having the same sequence as the flag sequence on a transmitter side according to a preferred embodiment of the present invention. Table 1 shows the data sequences that are checked in a direction from a lower data sequence to a higher data sequence. It will be apparent to those skilled in the art that the present invention is easily applied to the case where data sequences are checked in a direction from a higher data sequence to a lower data sequence.

TABLE 1

| Input | | | | | |
|---|---|---|---|---|---|
| Attributes of | | | | | |
| previous unit | | Output | | | |
| data sequences | Input unit data | Output unit data | Attributes | | |
| s | sequences | sequences (t) | s | i | b |
| 0 | 10101010 (MSB) | 10101010 (MSB) | 0 | 0 | |
| 1 | 10010111 | 10010111 | 3 | 0 | |
| 2 | 11110101 | 11101010 | 1 | 1 | 1 |
| 4 | 11111111 | 10111110 | 2 | 2 | 11 |

In Table 1, all possible unit data sequences and a set of values of attribute s are provided as indices, and output unit data sequences t and attributes s, i, and b are stored in correspondence with the indices. Herein, as a matter of convenience for memory operation, Table 1 includes output data sequences, which are generated by alternatively inserting dummy bits into the input data sequerices, to be classified and stored to output unit data sequences t and attribute b. That is, the output data sequence of 8 bits at a lower position is stored to the output unit data sequences t, but the other upper data sequences exceeding the 8 bits caused by insertion of the dummy bits are stored to the attribute b. Alternatively, it is possible to store the output data sequences without classification as they are. In this case, it should be noted that it is unnecessary to use the attribute b. Hereinafter, description will be made on the assumption that the output unit data sequences are fixed by a 1-byte.

The attribute s indicates the number of consecutive “1” bits on the basis of a most significant bit (MSB) of the output data sequence. Herein, the attribute s may be indicated as a value from 0 to 5. The attribute s is used as a table index while in order to sense the case that the consecutive “1” bits are more than 5 over two input unit data sequences, subsequent input unit data sequence is checked. The attribute i indicates the number of dummy bits or “0” bits which are inserted into the input unit data sequences.

In the first input unit data sequence, five consecutive “1” bits are not present, so that the output data sequence is equal to the input unit data sequence, and attributes s and i are each set as a value of 0. In the second input unit data sequence, five consecutive “1” bits are not present so that the output data sequence is equal to the input unit data sequence. However, the number of consecutive “1” bits is 3, starting from the MSB of the output data sequence, the attribute s is set as a value of 3.

In the third input unit data sequence, the number of consecutive “1” bits is 2, starting from the MSB of output data sequence related to previous input unit data sequence, and the number of consecutive “1” bits is 4, starting from a least significant bit (LSB) of the present input unit data sequence. Here, six consecutive “1” bits appear over two input unit data sequences, so that the dummy bit or “0” bit is inserted after the third bit starting from LSB of the present input unit data sequence. That is, the output data sequence is 111010101, of which 8 bits at a lower position, i.e., 11101010 are stored as the output unit data sequence, and MSB of the output data sequence, i.e., 1 is stored to the attribute b. Then, the attribute s is 1, and the attribute i is 1.

In of the fourth input unit data sequence, the attribute s of previous unit data sequence is 4, the dummy bit is inserted into the second bit starting from LSB, and the dummy bit is inserted again after the “1” bit is repeated 5 times (five consecutive “1” bits), and thus output data sequence becomes 1011111011. Here, 8 bits at a lower position, i.e., 10111110 become the output unit data sequence of the other upper 2 bits, i.e., 11, becomes the attribute b. Further, the attribute s is 2, while the attribute i is 2.

Table 2 shows a part of the table used to remove dummy bits, which are inserted unit data sequences received on a receiver side according to a preferred embodiment of the present invention.

TABLE 2

| Input | | | | | |
|---|---|---|---|---|---|
| Attributes of | | | | | |
| previous unit | | Output | | | |
| data sequences | Input unit data | Output unit data | Attributes | | |
| s | sequences | sequences (t) | s | i | b |
| 0 | 10101010 (MSB) | 10101010 (MSB) | 0 | 0 | 0 |
| 1 | 10010111 | 10010111 | 3 | 0 | 0 |
| 2 | 11101010 | 1111010X | 0 | 1 | 0 |
| 0 | 01111110 | 01111110 | 0 | 0 | H |
| 5 | 01111101 | 1111111X | 1 | 2 | 0 |
| 5 | 10111110 | 1011111X | 0 | 1 | E |
| 4 | 11111111 | 11111111 | X | 0 | E |

Similar to Table 1, in Table 2, all possible unit data sequences and a set of values of attribute s are provided as indices. Of the Attributes, s indicates the number of consecutive “1” bits on the basis of MSB of the input unit data sequence, and x indicates the number of dummy bits or “0” bits which are removed from the input unit data sequence. Further, c indicates characteristics of the input unit data sequence, that is, whether an error is generated from a received input unit data sequence, and whether the input unit data sequence belongs to a HDLC flag. Here, if the input unit data sequence belongs to the HDLC flag, c is set as a value of H. If an error is generated, c is set as a value of E. The error includes when the a “1” bit is sequentially continued up to more than 6. In addition, when normal data sequence is input, c is set as a value of 0.

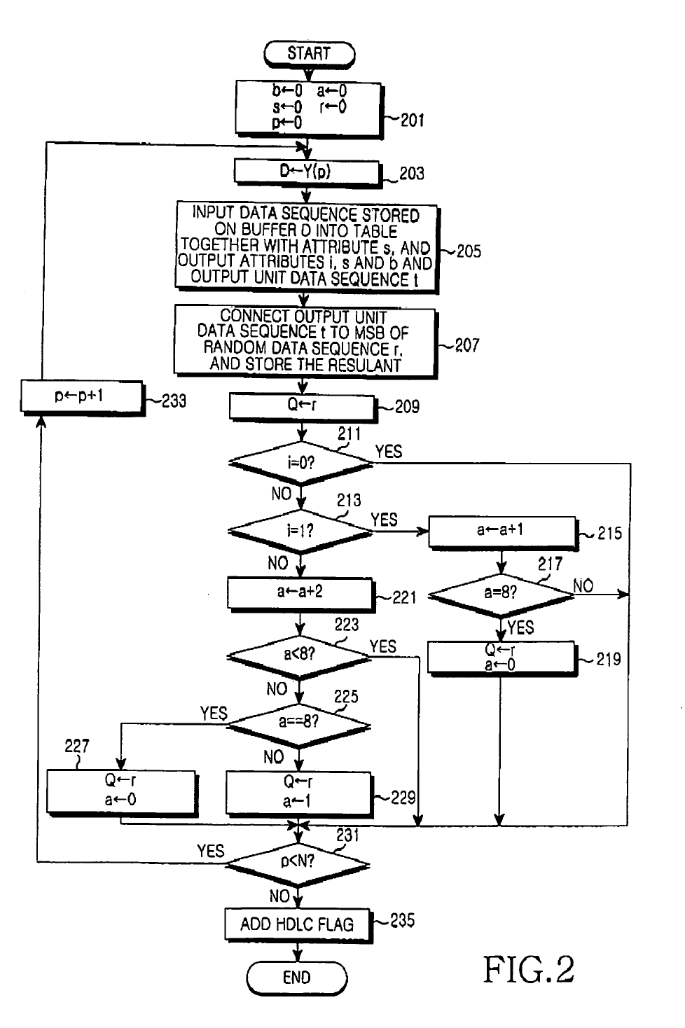

FIG. 2 is a flow chart illustrating a method for alternatively inserting dummy bits into data sequences, which are to be transmitted on a transmitter side, according to a preferred embodiment of the present invention. Hereinafter, a detailed description will be made with reference to FIG. 2, regarding a method for alternatively inserting dummy bits in order to prevent data sequences having the same sequence as a flag sequence from being transmitted on a transmitter side.

Referring to FIG. 2, in step 201, buffers S and B for storing attributes s and b are initialized. It should be noted that attributes defined in Table 1 are represented in FIG. 2 using the same characters. Further, buffer R for storing a random data sequence r is initialized, and a variable a is initialized which represents the number of bits of a data sequence stored on the buffer R. In addition, a variable p for counting a unit data sequence from among an original data sequence to be transmitted, as will be described below. Also, even though not shown in the figure, a buffer I for storing attribute i is initialized.

In step 203, a p^{th} byte, Y(p), of the original data sequence Y(k) (k=0, 1, . . . , N−1) to be transmitted is stored on the buffer D having a size of one byte, in which the original data sequence Y(k) has a length of N bytes. In step 205, a data sequence stored as an input unit data sequence on the buffer D is input as an index into a table, as shown in Table 1, together with a value of the attribute s. An output unit data sequence t corresponding to the index is stored on a buffer T having a size of 1 byte. Further, the attributes s, i and b of the input unit data sequence are output to be stored on the buffers S, I and B, respectively. Here, it should be noted that the attribute b is an unwanted one when the size of the buffer T is defined as 1 byte, as mentioned above.

In step 207, both the bit sequence stored on the buffer B and the output unit data sequence t stored on the buffer T are connected to upper bits of the random data sequence r stored on the buffer R, and the resultant is stored on the buffer R. For example, when a data sequence 1011 is stored on the buffer R, a data sequence 10001111 is stored on the buffer T, and a bit sequence 11 is stored on the buffer B, a bit sequence 11100011111011 is stored on the buffer R in step 207. Here, the bit sequence stored on the buffer R is defined as a temporary output bit sequence or temporary output data sequence.

In step 209, a 1 byte at a lower position of the temporary output bit sequence stored on the buffer R is a final output unit data sequence with output one sequence shifted rightward by 8 bits. That is, only the remaining data sequence other than the data sequence of 1 byte, which is stored on an output buffer Q, from among the temporary output bit sequence is stored on the buffer R.

In step 211, it is determined whether a dummy bit is inserted or whether the attribute i stored on the buffer I is a value of 0. If the dummy bit is not inserted, step 211 proceeds to step 231. However, if the dummy bit is inserted, step 211 proceeds to step 213, where it is determined how many of the dummy bits are inserted. If one dummy bit is inserted, step 213 proceeds to step 215, where the value of the attribute a is made greater by 1, and then step 215 proceeds to step 217. In step 217, it is determined whether the bit sequence stored on the buffer R is made up of one byte. If the bit sequence of 1 byte is already stored on the buffer R, the bit sequence stored on the buffer R is stored on the buffer Q as the final output unit data sequence in step 219, and the attribute a is initialized. However, when it is determined in step 217 that the bit sequence less than 1 byte is stored on the buffer R, because it is not yet enough to make up the unit data sequence, step 217 proceeds to step 231.

Returning to step 213, if the number of inserted dummy bits is more than one (1), for instance, two (2), the value of the attribute a, which represents the number of the bit sequence stored on the buffer R in step 221, is made greater by 2, and then step 221 proceeds to step 223. In this case, because the present invention processes the data sequence to be transmitted by a unit of 1 byte and makes use of the HDLC flag of 01111110 (0×7e), the maximal number of insertable dummy bits is 2. However, it will be apparent to those skilled in the art that modification or change may be made in this case.

In step 223, it is determined whether the bit sequence stored on the buffer R is more than 1 byte or 8 bits. If the bit sequence is not made up of 1 byte, step 223 proceeds to step 231, but if the bit sequence is more than 8 bits, step 223 proceeds to step 225. In step 225, it is determined whether the bit sequence stored on the buffer R exceeds 1 byte. If the bit sequence of 1 byte is stored, step 225 proceeds to step 227. In step 227, the bit sequence stored on the buffer R is stored on the buffer Q as the final output unit data sequence, and the attribute a is initialized. However, when it is determined that the bit sequence exceeding 1 byte is stored on the buffer R in step 225, only a lower 1 byte from among the bit sequence stored on the buffer R in step 229 is stored on the buffer Q, and the bit sequence of the buffer R is shifted rightward by 8 bits. Here, the value of the attribute a is set as 1.

In step 231, the attribute p is compared with the length N of the original data sequence to be transmitted. If p is smaller than N, p is made greater by 1 in step 233, and then step 233 returns to step 203. However, if p is the same as N, which means that the original data sequence is processed as a whole, step 231 proceeds to step 235. In step 235, the HDLC flag is added to the fame, and then the routine is terminated.

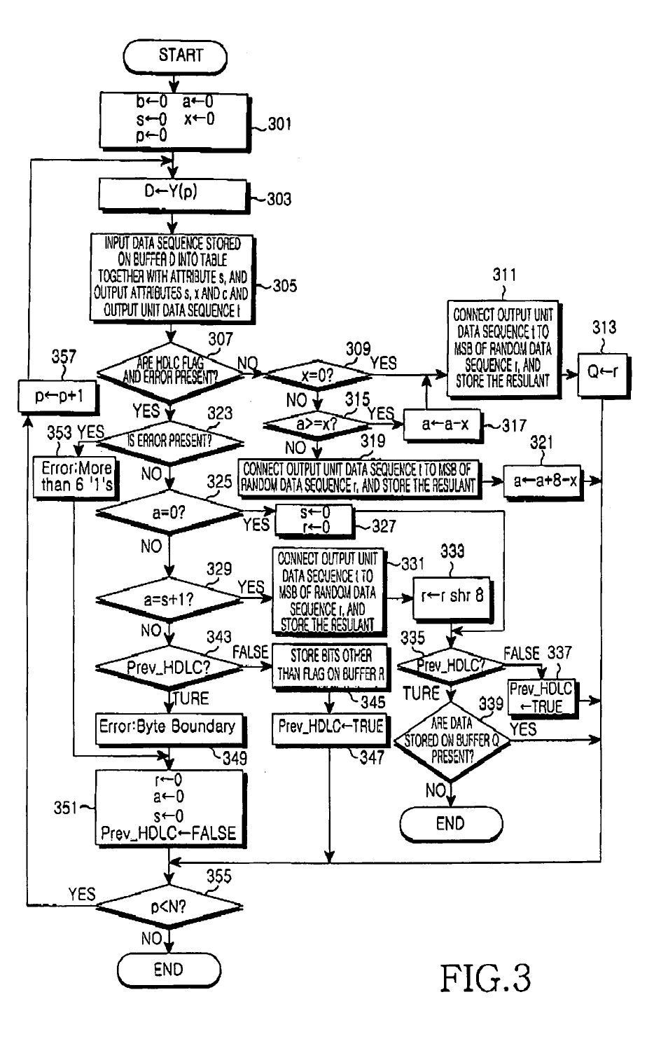

FIG. 3 is a flow chart illustrating a method for removing dummy bits from data sequences, which are received from a receiver side according to a preferred embodiment of the present invention. Hereinafter, a detailed description will be made with reference to FIG. 3, regarding a method for removing inserted dummy bits in order to prevent data sequences having the same sequence as a flag sequence from being transmitted.

Referring to FIG. 3, in step 301, buffers X and S for storing attributes x and s are initialized. It should be noted that the attributes defined in Table 2 are represented in FIG. 3 using the same characters. Further, a buffer R for storing a random data sequence r is initialized together with a buffer A on which the attribute a for representing a length of the bit sequence stored on the buffer R. In addition, a variable p for counting a unit data sequence from among a received original data sequence, as will be described below.

In step 303, a p^{th} byte Y(p) of the received original data sequence Y(k) (k=0, 1, . . . , N−1) is stored on the buffer D having a size of 1 byte, in which the original data sequence Y(k) has a length of N bytes. In step 305, both a data sequence stored on the buffer D and a value of the attribute s are input into a table, as shown in Table 2, as an input unit data sequence. The corresponding output unit data sequence t is stored on a buffer T having a size of 1 byte. Further, the attributes s and x of the. input unit data sequence are output and stored on the buffers S and X, respectively. In addition, the attribute c is output.

In step 307, it is checked whether the input unit data sequence belongs to the HDLC flag or whether an error is present within the input unit data sequence. If the attribute c output from the table has a value of H, it is determined that the input data sequence belongs to the HDLC flag. If c has a value of E, it is determined that an error is present within the input unit data sequence. If the input unit data sequence does not belong to the HDLC flag without an error, step 307 proceeds to step 309, and then a typical procedure for removing the dummy bits is performed.

In step 309, it is checked whether the removed dummy bits are present. If the removed dummy bits are not present, step 309 proceeds to step 311. However, if the removed dummy bits are present, step 309 proceeds to step 315. In step 315, the length a of the bit sequence stored on the buffer R is compared with the number x of the removed dummy bits. If a is equal or greater than x, step 315 proceeds to step 317. Here, adding the number of bits of the output unit data sequence t to the number of bits of the random data sequence r is greater than 1 byte. In step 317, a value subtracting x from a is stored to a, and then step 317 proceeds to step 311. By contrast, if a is smaller than x, step 315 proceeds to step 319. Here, even adding the number of bits of the output unit data sequence t to the number of bits of the random data sequence r, is not made up of 1 byte. In step 321, a value adding the number of bits of the random data sequence r to the number of bits of the output unit data sequence t, i.e., a+(8−x) is set as a value of a, and then step 321 proceeds to step 355.

If the removed dummy bits are not present or if the number of bits of the random data sequence r plus the number of bits of the output unit data sequence t form 1 byte, the bit sequence of the output unit data sequence t is connected to just upper bits of MSB of the bit sequence of the random data sequence r of the buffer R in step 311, and the resultant is stored. In step 313, lower 1 byte from among the bit sequence of the random data sequence r is stored on the buffer Q as the final output unit data sequence, and the bit sequence of the random data sequence r is shifted rightward by 8 bits. Then, step 313 proceeds to step 355.

However, if the input unit data sequence belongs to the HDLC flag or if an error is present within the input unit data sequence in step 307, step 307 proceeds to step 323. In step 323, when it is determined that an error is present within the input unit data sequence, step 323 proceeds to step 353. The error is generated when the received data sequence includes six consecutive “1” bits.

In step 323, when it is determined that the input unit data sequence belongs to the HDLC flag, step 323 proceeds to step 325. In step 325, it is determined whether the bit sequence stored on the buffer R is present. If the bit sequence stored on the buffer R is not present, it is determined that the input unit data sequence itself belongs to the HDLC flag, and then step 325 proceeds to step 327. In step 327, the attributes s and r are initialized, and then step 327 proceeds to step 335. In step 335, it is checked whether the detected HDLC flag is either an opening flag or an ending flag. Here, Prev_HDLC is a variable which is set to have a value of True when the opening flag is detected. If Prev_HDLC has a value of False, that is, if the opening flag is not yet received, the detected HDLC flag is determined as the opening flag. Then, step 335 proceeds to step 337. In step 337, Prev_HDLC is set as the value of True. However, when Prev_HDLC is already set as the value of True in step 335, this means that the opening flag is already received. In this case, the detected HDLC flag is determined as the ending flag, step 335 proceeds to step 339. In step 339, it is checked whether data stored on the buffer Q is present. If data stored on the buffer Q are not present, it is determined that the procedure for removing the dummy bits with respect to one PDU is completed, and then the routine is terminated. However, if data stored on the buffer Q is present, step 339 proceeds to step 355. That is, when one or more flag is sequentially received without received data, flags received subsequently after the first are neglected.

Meanwhile, if the bit sequence stored on the buffer R is present in step 325, it is determined that a part of the input unit data sequence constitutes the HDLC flag together with the bit sequence stored on the buffer R, and then step 325 proceeds to step 329. In step 329, it is checked whether the number of dummy bits inserted on the transmitter side is matched with that removed on the receiver side. That is, it is checked whether the total number of bits of the data sequence removing dummy bits from the received data sequence is a multiple of 8.

More specifically, the last of the frame is in the form of “0111 1110”. Thus, if the bits (a) left in the frame is 3, the form becomes “011”. That is, in case of being a=s+l at step 329, it is the last byte of the frame and it is capable of dividing the frame by the unit of byte. Thus, it is possible to check whether or not the total number of bit of data sequence is a multiple of 8. Herein, if a is 7 then, it meets with “a=s+1” and if a is 8 then, it is accomplished at step 325. Thus, it is unnecessary to consider the same at step 329.

If the number of inserted dummy bits is matched with the number of removed dummy bits, step 329 proceeds to step 331 and the output unit data sequence t is connected to upper bits starting from MSB of the random data sequence r of the buffer R and the resultant is stored. Here, the bit sequence stored on the buffer R becomes the HDLC flag. In step 333, the bit sequence of the random data sequence r is shifted rightward by 8 bits. Then, step 333 proceeds to step 335.

However, if the number of inserted dummy bits is not matched with the number of removed dummy bits, step 329 proceeds to step 343. In step 343, it is checked whether the detected HDLC flag is the opening flag. If Prev_HDLC has the value of False, it is determined that the detected HDLC flag is a new opening flag, and then step 343 proceeds to step 345. In step 345, the remaining bit sequence other than the opening flag is stored on the buffer R, and the number of bits of the remaining bit sequence is stored to the attribute a. In step 347, Prev_HDLC is set as the value of True. Then, step 347 proceeds to step 355.

However, if Prev_HDLC has the value of True in step 343, this means that the opening flag is already present, and thus the number of inserted bits within one frame is different from the number of removed bits, and it is determined that an error is generated, at step 349. Then, step 343 proceeds to step 351.

In step 351, the attributes r, a and s are initialized, and Prev_HDLC is set as the value of False. Then, step 351 proceeds to step 355. In step 355, it is determined whether the unit data sequence processed for the present time is the last unit data sequence of the received original data sequence. If it is not the last unit data sequence, a value of the attribute p is made greater by 1 in step 357. Then, step 357 returns to step 303. However, if the unit data sequence processed for the present time is the last unit data sequence, the routine is terminated.

As is described above, the present invention has an advantage in that it can prevent an overload of a system by processing data sequences of data frames by a unit of a byte rather than by a unit of bit. Further, the present invention has another advantage in that it can enhance a processing rate of the procedure for inserting dummy bits by checking the data sequences of the data frames in a lump using a table.

While preferred embodiments of the present invention have been described for illustrative purposes, it is contemplated that various alternatives, modifications, additions, substitutions, and equivalents thereof will become apparent to those skilled in the art upon a reading df the specification and study of the drawings, without departing from the scope and spirit of the invention as disclosed in the following appended claims. It is therefore intended that the appended claims include all such alternatives, modifications, additions, substitutions, and equivalents as fall within the spirit and scope of the present invention.

What is claimed is:

1. A method for synchronizing data frames in order to prevent transmission of a same data sequence as a flag sequence in a communication system in which a start and an end of each data frame having a data sequence to be transmitted are indicated using flags, and the flags have a sequence including a sequence of bits in which a value of the bit is sequentially continued up to a predetermined number, the method comprising the steps of:
classifying the data sequence into N unit data sequences having a predetermined bit number and inputting an n^{th} unit data sequence to be checked from among the N unit data sequences into a predetermined table as indices; and
outputting output data sequences from the table in correspondence to the indices together with at least one attribute, the output data sequences having dummy bits which are alternatively inserted into the unit data sequences, the at least one attribute indicating a number of the bit values which are sequentially continued starting from a most significant bit (MSB) of the output data sequence, the indices including an attribute output from the table with respect to an n-1^{th} unit data sequence.

2. The method according to claim 1, wherein the table stores the output data sequences having alternatively inserted dummy bits, values of the attributes corresponding to all possible unit data sequences, and. a set of all values for which the attributes allow.

3. The method according to claim 1, further comprising the steps of:
forming a temporary output data sequence from the output data sequence for the n^{th} unit data sequence; and
classifying the temporary output data sequence into an output unit data sequence having a predetermined bit number and into a remaining data sequence,
wherein the temporary output data sequence includes a remaining data sequence for the n-1^{th} unit data sequence.

4. The method according to claim 3, further comprising the step of re-classifying the remaining data sequence into an output unit data sequence having the predetermined bit number and a new remaining data sequence, when the bit number of the remaining data sequence is greater than the predetermined bit number.

5. A method for synchronizing received data frames in a communication system in which a start and an end of each data frame having a data sequence are indicated using a flag, and the flag has a sequence including a sequence of bits in which a value of the bit is sequentially continued up to a predetermined number, the method comprising the steps of:
classifying a received data sequence into N unit data sequences having a predetermined bit number;
defining at least one attribute of an n-1^{th} unit data sequence from among the N unit data sequences, the at least one attribute indicating a number of the bit values which are sequentially continued starting from a most significant bit (MSB) of the corresponding unit data sequence; and
inputting attributes of an n^{th} unit data sequence and the n-1^{th} unit data sequence into a table, and outputting attributes of the corresponding output data sequence and the n^{th} unit data sequence.

6. The method according to claim 5, wherein the table stores the output data sequences in which alternatively inserted dummy bits are removed, the corresponding attributes of all possible unit data sequences, and a set of values of the attributes.

7. The method according to claim 5, further comprising the steps of:
forming a temporary output data sequence from the output data sequence for the n^{th} unit data sequence; and
classifying the temporary output data sequence into an output unit data sequence constituted by the predetermined bit number and into a remaining data sequence,
wherein the temporary output data sequence includes a remaining data sequence for the n-1^{th} unit data sequence.

8. The method according to claim 7, further comprising the step of re-classifying the remaining data sequence into an output unit data sequence having the predetermined bit number and a new remaining data sequence, when the bit number of the remaining data sequence is greater than the predetermined bit number.

9. A method for synchronizing data frames in a communication system in which a start and an end of each data frame having a data sequence to be transmitted are indicated using flags having a predetermined sequence, the method comprising the steps of:
classifying the data sequence into a plurality of unit data sequences having a predetermined bit number, and sequentially inputting the unit data sequences into a predetermined table as indices;
outputting output data sequences from the table in correspondence to the indices, the output data sequences having dummy bits which are alternatively inserted; and
forming the data frame from the output data sequences, and attaching the flags to front and rear ends of the data frame, respectively.

10. The method according to claim 9, wherein the table stores the output data sequences having alternatively inserted dummy bits in correspondence to all possible unit data sequences in order to prevent at least one data sequence having a same sequence as a sequence of the flag from being transmitted.

11. The method according to claim 10, wherein the sequence of the flag contains a bit sequence in which a predetermined value of the bit is sequentially continued up to a predetermined number.

12. The method according to claim 11, wherein the table stores the number of the predetermined bit values which are sequentially continued starting from a most significant bit of the output data sequence as values of the attributes of each output data sequence.

13. The method according to claim 12, wherein the indices include the values of the attributes.

14. The method according to claim 9, further comprising the steps of:
forming a temporary output data sequence from the output data sequence; and
forming the temporary output data sequence into an output unit data sequence having a predetermined bit number and into a remaining data sequence; and
connecting the remaining data sequence to a next output data sequence output sequentially, and forming a temporary output data sequence for the next output data sequence.

15. The method according to claim 14, further comprising the step of re-forming the remaining data sequence into an output unit data sequence and a new remaining data sequence, when the bit number of the remaining data sequence is greater than the predetermined bit number.

16. A method for receiving and synchronizing data frames in a communication system in which a start and an end of each data frame having a data sequence are indicated using flags having a predetermined sequence, and dummy bits are alternatively inserted into data sequences of the data frames to prevent a data sequence having a same sequence as the flag sequence from being transmitted, the method comprising the steps of:
classifying a received data sequence into a plurality of unit data sequences having a predetermined bit number; and
sequentially inputting the unit data sequences into a predetermined table, and sequentially outputting the output data sequences from which the dummy bits are removed from the table in correspondence to the input unit data sequences.

17. The method according to claim 16, wherein the table stores the output data sequences from which the dummy bits are removed in correspondence to all possible unit data sequences.

18. The method according to claim 17, wherein the sequence of the flag contains a bit sequence in which a predetermined value of the bit is sequentially continued up to a predetermined number.

19. The method according to claim 18, wherein the table stores the number of the predetermined bit values which are sequentially continued starting from a most significant bit of the output data sequence as values of attributes of each output data sequence.

20. The method according to claim 19, wherein the values of the attributes are included in indices of the table.

21. The method according to claim 16, further comprising the steps of:
forming a temporary output data sequence from the output data sequences;
forming the temporary output data sequence into an output unit data sequence having a predetermined bit number and into a remaining data sequence; and
connecting the remaining data sequence to a next output data sequence output sequentially, and forming a temporary output data sequence for the next output data sequence.

22. The method according to claim 21, further comprising the step of re-forming the remaining data sequence into an output unit data sequence and a new remaining data sequence, when the bit number of the remaining data sequence is greater than the predetermined bit number.
